(19) United States
(12) Patent Application Publication
(10) Pub. No.: US 2010/0169148 A1
(43) Pub. Date: Jul. 1, 2010

(54) INTERACTION SOLUTIONS FOR CUSTOMER SUPPORT

(75) Inventors: Martin Oberhofer, Bondorf (DE); Albert Maier, Tuebingen (DE); Thomas Schwarz, Stuffgart (DE); Sebastian Krebs, Nierstein (DE); Dirk Nowak, Nierstein (DE)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/347,222

(22) Filed: Dec. 31, 2008

(51) Int. Cl. G06Q 10/00; G06Q 50/00; G06F 17/30; G06F 7/06

(52) U.S. Cl. 705/9; 705/11; 705/10; 707/E17.017

(57) ABSTRACT

The present invention provides a system, architecture and process to support new interaction paradigms in customer support. Specifically, the approach of the present invention will unify through a new process and innovative system architecture the two basic methods of in house support and online support. To accomplish this unification, the present invention enables customers to work together as peers in problem resolution by exploiting the customer expertise (they work with the products on a daily basis and often have deep understanding what works/does not work). Among other things, the present invention provides: incentives for customers to participate in this new support; a rating infrastructure in which multiple good ratings helps to become “THE EXPERT” by increasing the score; incentives upon receipt of good ratings and or certain score levels; a problem routing mechanism; Master Data Management (MDM) for insights in customers and products.

### FIELD OF THE INVENTION

The present invention generally relates to customer support. Specifically, the present invention relates to interaction solutions and problem resolution optimization in the customer care process.

### BACKGROUND OF THE INVENTION

Today, there are essentially two ways to provide customer support: (1) In House Support: Based on a support contract with Service Level Agreements (SLAs) between product producer and product buyer (the customer) with ensured problem resolution times. The product producer therefore has typically a dedicated support organization with paid employees resolving problems reported by customers. An in house support infrastructure can include a typical backend system, an online system or a combination thereof. (2) Online Support: Online forums where problems can be posted and anyone can answer. A typical example is a developer forum where anyone can post a problem message. However, there is no guarantee if and when someone will answer because there are no SLAs based on a support contract in place. Key differences to in-house support include the following: there is no guarantee that the problem will be solved at all; there is no guarantee regarding the timeframe when the problem will be solved.

Many companies have both types of infrastructures today, but separately without any integration in between. This leads to negative consequences such as: a lack of consistent reporting regarding which parts of a product are having the most problems for example which need to be addressed in the next version with major quality improvements; a lack of consistent reporting regarding which people are the most effective problem solvers; a lack of consistent classification of problems and problem priorities is possible; resolved issues in one system are not found in searches in the other system. This causes that a customer might open another problem report for an already solved issue causing a waste of time in the support organizations; reduced customer loyalty; missed cost saving opportunities; the problem is not answered by the best available expert considering in house and online support; and “expert rank” is derived by social computing infrastructure which is not integrated with traditional in house support.

### SUMMARY OF THE INVENTION

The present invention provides a system, architecture and process to support new interaction paradigms in customer support. Specifically, the approach of the present invention will unify through a new process and innovative system architecture the two basic methods of in house support and online support. To accomplish this unification, the present invention enables customers to work together as peers in problem resolution by exploiting the customer expertise (they work with the products on a daily basis and often have deep understanding what works/does not work). Among other things, the present invention provides: incentives for customers to participate in this new support; a rating infrastructure in which multiple good ratings helps to become “THE EXPERT” by increasing the score; incentives upon receipt of good ratings and or certain score levels; a problem routing mechanism; Master Data Management (MDM) for insights in customers and products. Examples of MDM functions relevant for the present invention include the capability to:
Manage relationships between customers and manage organization hierarchies
Provide customer preferences for personalization such as “interested in performance problems”
Manage expert rank as part of the customer information: The score values are divided in ranges identifying expert ranks such as “Beginner” or “Top Expert”. A low score value would be the range for a “Beginner” whereas a high score value would fall in the range of “Top Expert” indicating someone who solved a lot of problems successfully.

A first aspect of the present invention provides a customer support method, comprising: performing a search for set of possible solutions to a problem, the set of possible solutions comprising online support and in-house support; identifying and notifying a peer to assist with resolution of the problem in response to a notification of the problem; receiving feedback on the set of possible solutions via a ratings system; and monitoring compliance with a Service Level Agreement (SLA) for both the in-house support and the online support in resolving the problem.

A second aspect of the present invention provides a customer support system, comprising: a module for performing a search for set of possible solutions to a problem, the set of possible solutions comprising online support and in-house support; module for identifying and notifying a peer to assist with resolution of the problem in response to a notification of the problem; a module for receiving feedback on the set of possible solutions via a ratings system; and a module for monitoring compliance with a Service Level Agreement (SLA) for both the in-house support and the online support in resolving the problem.

A third aspect of the present invention provides a computer readable medium containing a program product for customer support, the computer readable medium comprising instructions for causing a computer system to: perform a search for set of possible solutions to a problem, the set of possible solutions comprising online support and in-house support; identify and notifying a peer to assist with resolution of the problem in response to a notification of the problem; receive feedback on the set of possible solutions via a ratings system; and monitor compliance with a Service Level Agreement (SLA) for both the in-house support and the online support in resolving the problem.

A fourth aspect of the present invention provides a method for deploying an application for customer support, comprising: providing a computer infrastructure being operable to: perform a search for set of possible solutions to a problem, the set of possible solutions comprising online support and in-house support; identify and notifying a peer to assist with resolution of the problem in response to a notification of the problem; receive feedback on the set of possible solutions via a ratings system; and monitor compliance with a Service Level Agreement (SLA) for both the in-house support and the online support in resolving the problem.

A fifth aspect of the present invention provides a computer-implemented method for providing customer support method, comprising: performing a search for set of possible solutions to a problem, the set of possible solutions comprising online support and in-house support; identifying and notifying a peer to assist with resolution of the problem in response to a notification of the problem; receiving feedback on the set of possible solutions via a ratings system; and monitoring compliance with a Service Level Agreement (SLA) for both the in-house support and the online support in resolving the problem.

A sixth aspect of the present invention provides a data processing system for providing customer support, comprising: a memory medium containing instructions, a bus coupled to the memory medium, and a processor coupled to the bus that when executing the instructions causes to data processing system to: perform a search for set of possible solutions to a problem, the set of possible solutions comprising online support and in-house support; identify and notifying a peer to assist with resolution of the problem in response to a notification of the problem; receive feedback on the set of possible solutions via a ratings system; and monitor compliance with a Service Level Agreement (SLA) for both the in-house support and the online support in resolving the problem.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system architecture according to the present invention.

FIG. 2 depicts an illustrative peer customer care platform according to the present invention.

FIG. 3 depicts the process flow of searching for a solution to a problem according to the present invention.

FIGS. 4A-B depict a flow diagram for determining distribution rules according to the present invention.

FIG. 5 depicts a process flow for answering a problem according to the present invention.

FIG. 6 depicts a more specific computerized implementation of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

Prior to describing the invention, the following roles are defined:

Solution Searcher means the customer having a problem.

Peer is defined as another customer acting as peer to solve the problem.

Employee or Customer Care representative (CCR) is defined as a member of the customer care/support staff.

The first two actors are peers to each other among the customers themselves. The third actor is regarding the process also just a peer answering problems tearing down the distinction on this platform between employee (internal participant) and customer (external participant) and will be measured with the same metrics regarding rating scores, number of problems solved, etc as the external participants.

As indicated above, present invention provides a system, architecture and process to support new interaction paradigms in customer support. Specifically, the approach of the present invention will unify through a new process and innovative system architecture the two basic methods of in house support and online support. To accomplish this unification, the present invention enables customers to work together as peers in problem resolution by exploiting the customer expertise (they work with the products on a daily basis and often have deep understanding what works/does not work). Among other things, the present invention provides: incentives for customers to participate in this new support; a rating infrastructure in which multiple good ratings helps to become “THE EXPERT” by increasing the score; incentives upon receipt of good ratings and or certain score levels; a problem routing mechanism; Master Data Management (MDM) for insights in customers and products.

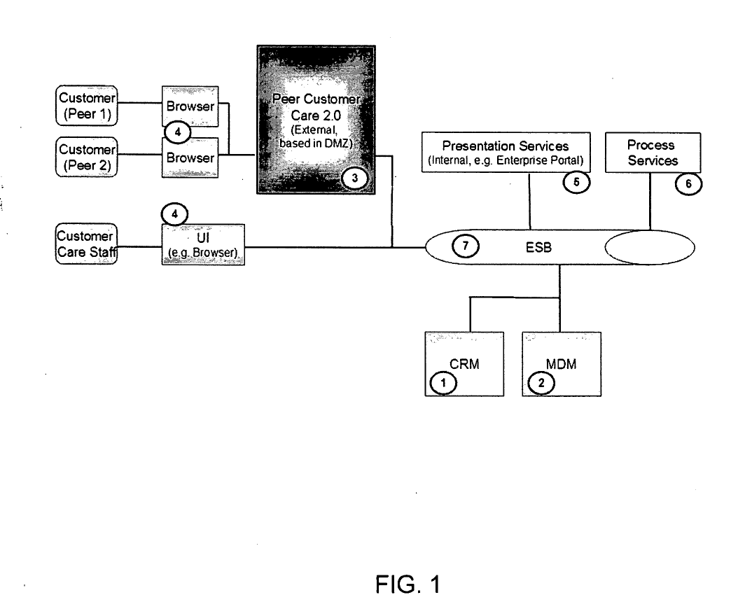

A high level system architecture will now be described starting with reference to FIG. 1. As depicted, the three critical systems are:
1. A Customer Relationship Management (CRM) System (1): This system is used for customer care processes like complaint support processing if a customer reports a problem. This system represents the in house support.
2. A Master Data Management (MDM) System (2): This system is used to manage customer and product master data with high quality efficiently. It provides high quality customer master data to
the CRM System and
the Peer Customer Care 2.0 platform (the online part of the solution where the customers interact as peers with each other). It furthermore manages also peer status, privacy and preference settings of all participants of the Support 2.0 Customer Care platform (the name for the complete solution).
3. The Peer Customer Care 2.0 platform (3): This is an online platform used by end customers as part of a new method supporting new interaction paradigms in customer support. It includes the following capabilities:
Automation of the new interaction paradigm of the customer support process described herein.
Forum infrastructure is provided. Additional capabilities from Web 2.0 such as blogs, wikis, etc. allow a more feature rich implementation of this system.
Rating peers for the solution provided to award “Peer of the month” or similar incentive awards or recognition as outstanding subject matter experts
Integrated search across heterogeneous content sources such as the forum and the CRM system (and optionally if present across wiki, blog, content management systems, etc.)
Monitoring component checking for problem expiry thresholds in the Peer Customer Care 2.0 platform

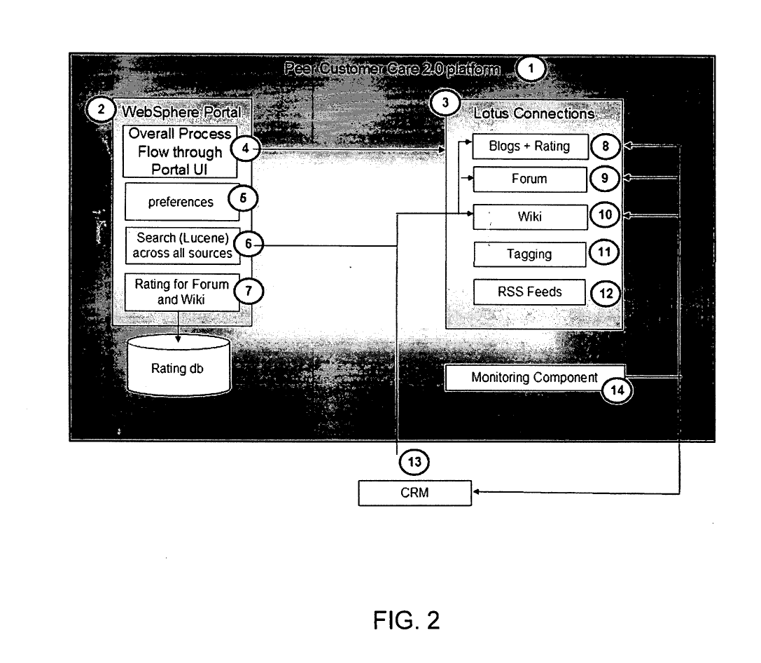

An example for the Peer Customer Care 2.0 system (system (3) in FIG. 1) is shown FIG. 2. As depicted, the Peer Customer Care 2.0 platform (1) is implemented using WebSphere Portal (2) and Lotus Connections (3) (Websphere, Lotus and related terms are trademarks of IBM Corp. in the United States and/or other countries). The overall support process would be driven from a customer perspective through logic (4) available through the WebSphere Portal to which the customer signs on. When the customer logs in, the customer preferences (5) are retrieved from the MDM System (component (2) in FIG. 1—this step is not shown in FIG. 2 for simplicity purposes) and the UI is customized based on the preferences for the customer. Once login has been completed, the customer having a problem can use a search portlet (6) running on the WebSphere Portal to search for a solution for the problem at hand. This can be implemented using the Lucene search engine for example. Note that here the first time already in house and online support are truly integrated: This search is not only searching in the online content repositories such as Blogs (8), Forums (9) and Wikis (10) but also in all in house systems such as CRM systems (13) for problem complaint processing. Here already the unification is taking place for the first time. If the customer doesn't find a solution, then a portlet running on the WebSphere Portal is used to submit a problem. Depending on problem report routing, the problem either is placed for example in a forum (9) or it is submitted to the in house support which means it ends up in the CRM system (13). Using RSS Feeds (12) appropriate subject matter experts which are the peers are notified that there is a problem requiring resolution and therefore their attention. Once the peer answers, the customer which submitted the problem is notified that there is an answer. Using Rating services (7) the problem searcher can rate the answer increasing the reputation score of the peer. The reputation score is a key factor regarding when the peer is entitled to one of the incentives (like peer of the month award, etc.). A monitoring component (14) ensures that throughout the process the problem resolution time as per the support contract is guaranteed with proper escalation mechanisms. For example, if a problem is not resolved in the forum (9) within a certain time smaller than the maximum resolution time, the problem can be automatically assigned to an in house employee with notification of this employee for immediate resolution.

Referring back to FIG. 1, the components (4) are used to access the systems (1) to (3). More specifically:
Customers use browsers to access the Peer Customer Care 2.0 platform and interact with it.
Customer Care Staff uses a user Interface (UI) which could be a browser as well depending on software selection for (1) and (2).
   The components (5) to (7) depend on software selection for the systems (1) to (3) and might or might not be there as individual component. Assuming a service-oriented architecture (SOA) environment, they would be typically representing:
Presentation Services (5): Both the CRM and the MDM System could have a web-based user interface which can be hosted on an Enterprise Portal for example. In this case, customer care staff could use browsers to access the user interface for the CRM and the MDM System.
Process Services (6): The customer care support process as outlined below has workflow requirements. In case an enterprise wide process services component such as a Process Server exists, these workflows would be executed by this component. Otherwise the Peer Customer Care 2.0 platform, the CRM and the MDM System need to have built-in functions to support the workflow requirements.
Enterprise Service Bus (7): This component for connectivity and interoperability reflects the need for the minimum systems (1) to (3) to communicate with each other. Also (5) and (6) could use this component for communication. This can be simple network infrastructure or a full-blown ESB with features to enable loose coupling of the systems, protocol abstraction, etc.

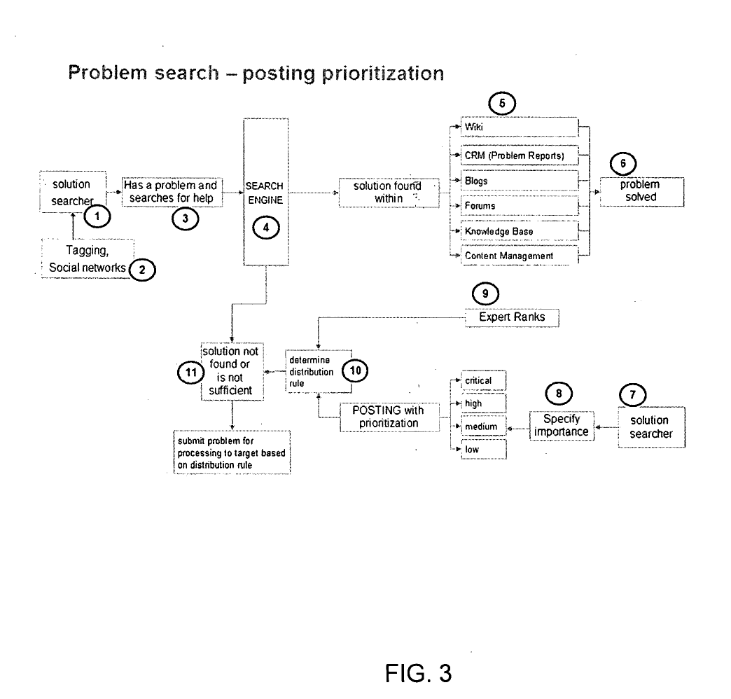

The process flow of the new interaction paradigms in customer support will now be explained. As such, two distinct phases will be described:
1. Searching for a solution of a problem
2. Answering a problem
   The first step is the search. The process starts when the solution searcher starts to search for a solution as shown in FIG. 3.
1. A customer in the role of solution searcher (1) signs on the Peer Customer Care 2.0 platform. This is component (3) in FIG. 1. The customer ID is managed by the MDM System (which is component (2) in FIG. 1). The solution searcher might have relationships to peers established due to previous participation in the Peer Customer Care 2.0 platform. These relationships as part of the social network (2) are managed by the MDM System as well to enable a 360 degree customer view. Based on tagging the status of the customer in the Peer Customer Care 2.0 platform could be given as a “rank” for example—information also managed by the MDM System. Based on preferences and privacy settings selected by the customer when signing on initially to the Peer Customer Care 2.0 platform the UI of the Peer Customer Care 2.0 platform is personalized. The privacy and preference information is managed by the MDM System.
2. The solution searcher (1) then uses the Peer Customer Care 2.0 UI component to initiate a search for a solution to a problem (3) using the Search Engine (4). The Search Engine is part of system (3) in FIG. 1.
3. The Search Engine (4) of the Peer Customer Care 2.0 platform searches for a solution in all content sources (5) such as the forum and the CRM system (and other content sources if present such as wikis, content management systems, etc.) and returns a result list if matches for the search are found.
4. The solution searcher (1) checks the result list. If a solution is found in the result list, the process terminates (6) and the problem is solved. Already here a customer as well as the company offering the Support 2.0 Customer Care platform benefit from it alike for the following reasons:
The search engine searches through all known solutions to all known problems. Thus there is a single place for the solution searcher to find out if a solution exists. This is one key aspect of this unification of in house and online support.
The company offering the Peer Customer Care 2.0 platform in the scope of the holistic Support 2.0 Customer Care platform benefits from it because a solution searcher more often finds a solution, redundant problem reporting is avoided reducing costs in internal customer care organizations.
5. If in the result list no solution or only a partial solution was found, the solution searcher opens a problem report. A key point now is that the problem posting is happening in an automated way based on distribution rules (10). The distribution rules are a basic mean of routing problems to the right person. It considers:
The posting priority (8) assigned by the problem searcher (7)
Expert rank (9) of the experts

The advantage of this distribution rule approach is that it notifies a suitable skilled person for problem solving in the context of the posting priority of the problem and considering cost reduction (e.g. skill is likely good enough in online support). For example, consider the following distribution rule table (note that rules are intended as examples—therefore the list is far from complete and intended as illustration only in Table 1):

TABLE 1
Distribution Rules

| | | | Rank of | |
|---|---|---|---|---|
| | Priority as | Rank of | best expert | |
| | assigned | best expert | in the in | |
| Row | by solution | in online | house | |
| number | searcher | support | support | Result |
| 1 | 1 (very | 1 (best | 1 (best | In House Support |
| | high) | rank) | rank) | (CRM System) |
| 2 | 1 (very | 1 (best | 2 (medium | In House Support |
| | high) | rank) | rank) | CRM System) |
| 3 | 1 (very | 2 (best | 1 (best | In House Support |
| | high) | rank) | rank) | (CRM System) |
| 4 | 2 (high) | 1 (best | 1 (best | Online Support |
| | | rank) | rank) | (Forum) |
| 5 | 2 (high) | 1 (best | 2 (medium | Online Support |
| | | rank) | rank) | (Forum) |
| 6 | 2 (high) | 2 (medium | 1 (best | Online Support |
| | | rank) | rank) | (Forum) |
| 7 | 2 (high) | 3 (low rank) | 1 (best | In House Support |
| | | | rank) | |
| 8 | 3 | 2 (medium | 1 (best | Online Support |
| | (medium) | rank) | rank) | (Forum) |
| 9 | 4 (low) | 3 (low rank) | 1 (best | Online Support |
| | | | rank) | (Forum) |
| 10 | Any | Any rank | Any Rank | Message was not |
| | priority | | | processed in |
| | | | | Peer Customer |
| | | | | Care 2.0 system |
| | | | | or exceeded |
| | | | | maximum |
| | | | | completion time |
| | | | | for Peer |
| | | | | Customer Care |
| | | | | 2.0 - in this case |
| | | | | the problem will |
| | | | | be routed to in |
| | | | | house support for |
| | | | | processing as |
| | | | | escalation step |
| | | | | ensuring support |
| | | | | SLA |

Rows 1-3 illustrate for example that as per business decision all very high problem messages should be routed to the in house support organization independent from the expert rank. This becomes particularly obvious in row 2 where the online support team has a higher ranked expert. Rows 4-6 are an example that as per business decision all high priority problems are routed to online support first if an expert of rank “best rank” or “medium rank” exists thus offloading in house support.

Row 7 indicates if the expert rank for online support for problems with high priority falls below medium rank and a better expert is available in the in house organization, the problem will be routed there. This is an example where the distribution rule algorithm routes the problem to a more skilled person.

Row 8 and 9 reflect the idea of cost reduction in the in house support organization. Even if there would be better skills available in the in house support organization compared to online support delivered through customer peers you could route these problems to the online support first.

Row 10 shows a rule ensuring the SLA contract for support with the clients. If the problem message has not been processed at all or only partial solutions have been provided by the Peer Customer 2.0 platform until a certain threshold is reached, then the problem has to be routed to in house support with proper escalation mechanism including notifications, etc. Note that there can be more than one rule of this type (e.g. one per priority of problem message). Furthermore, note that the expiry time threshold has to be checked with a monitoring component illustrated with (14) in FIG. 2 which is part of the Peer Customer Care 2.0 platform.

Note that a complete distribution rule table has a complete set of rules for all problem priorities and rank combinations of experts in the in house and online support group with a routing instruction. Therefore, the distribution rule algorithm will always make an assignment of the problem message.

Based on these simple rules leveraging customer expertise in problem solving the Peer Customer Care 2.0 platform computes based on distribution rules (10) to which target the problem is routed (11). Also note that the information from the MDM System is critical to support the Peer Customer Care 2.0 platform here in the support process. The reason for this is that the distribution rules take into consideration the rank of the peers which are managed by the MDM system which stores customer and employee information alike.

For step 10 in FIG. 3 the distribution rules table is a basic mechanism which can be further improved because the distribution rule table does not consider customer importance based on profitability metrics, peer performance, etc.

The distribution rule algorithm now described is therefore a more advanced configuration of this invention delivering even more business benefits.

The below sections discusses this in greater detail. Specifically, in this section it is mentioned where the distribution rules algorithm works as part of the overall support process. In addition, the distribution rules algorithm replaces or supplements the logic related to (9) and (10) in FIG. 2 in the search and submission part of the process. From here on we assume the distribution rules algorithm in the discussion instead of the distribution rule table described above.

For a Distribution Rules Algorithm, the following is needed:

Input:
The input is a problem message containing:
peer identification submitting it
company employing the peer
problem title
problem description containing product names, versions, etc.
priority indicator
time of problem submission

Such a message is triggering the Distribution Rules Algorithm in one of the following three cases:
A new problem message was submitted by a problem searcher
An answer was rated as incomplete (anything smaller than the maximum possible credit score) triggering an inquiry for the remaining part of the problem
The monitoring component (see FIG. 2, component (14)) detects based on the expiry timeouts that a problem message not yet taken care of requires re-routing and escalation. Alternatively a problem scheduler could be used to re-submit the problem message to the Distribution Rules Algorithm based on an expiry time.
   The entry point for all three cases to the algorithm is the same.

The Distribution Rules Algorithm

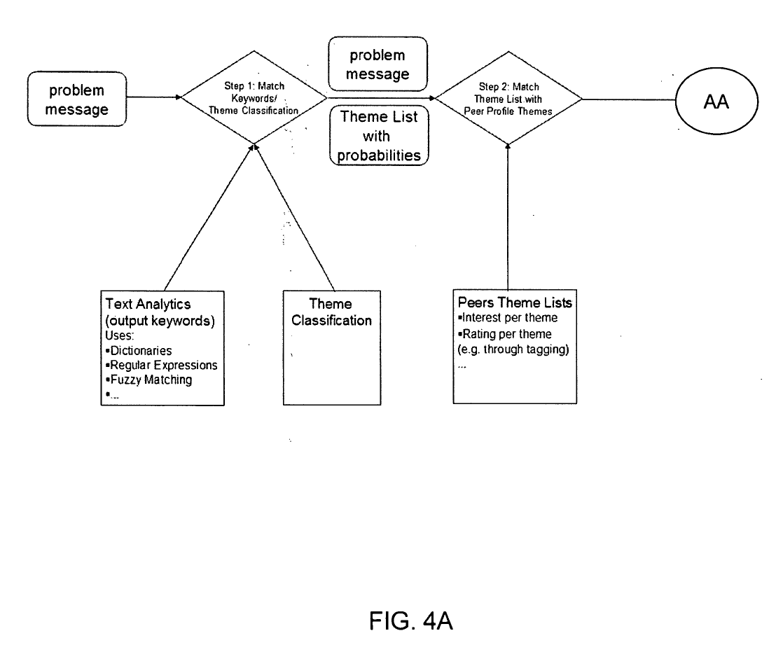

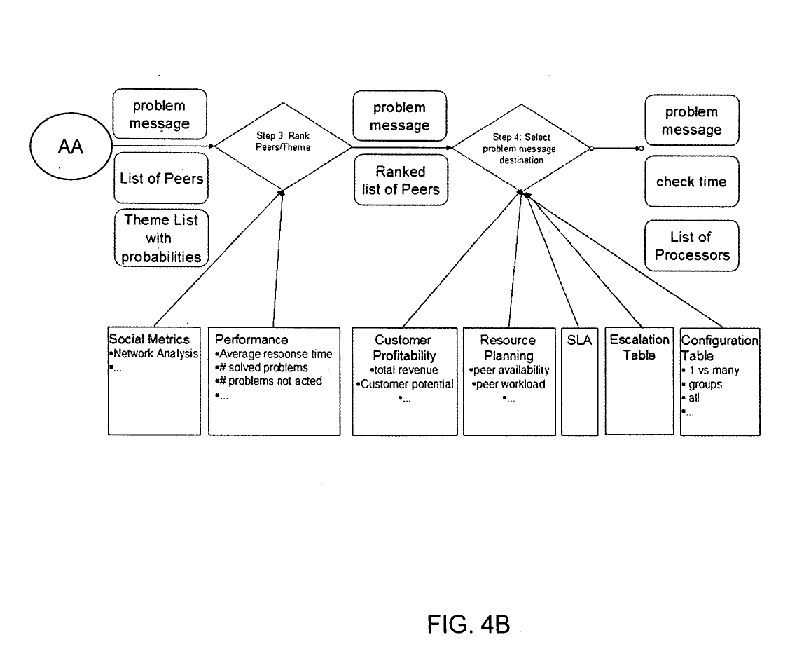

It is assumed the program representing the Distribution Rules Algorithm started successfully and has loaded all configuration parameters successfully. At some point in time after start, the first problem message and later on subsequent problem messages will be received. This is the point where we describe how the algorithm works in principal. In FIGS. 4A-B, we use the following graphical conventions:
Rectangles with “round” corners: problem message moving through the algorithm with additional boxes of this type if additional information is added to the problem message
“Diamonds”: Processing step
Rectangles with corners: specific input information for this processing step
   The algorithm starts when a problem message is received for routing.

Step 1 in FIG. 4A: In this step, the text of the received problem message is sent to a text analytical processing component which uses appropriate text analytical means to find out which is/are the likely keyword/keywords to which the problem message is related on a fine granular level. The text analytical processing component provides as input to this step a in a very simple implementation a list of keywords with 1 to n keywords with a probability per keyword how likely the keyword was identified correctly. In case the text analytical processing can't identify any keyword, a default list has to be returned which could be an indicator that the problem message can belong into any problem area. The second input for step 1 is the theme classification which is coarse granular. This could be a dictionary of problem area categories such as “performance”, “install”, “driver”, etc. Based on these two input sources, in step 1 the keyword list of the analytical text processing is matched with the theme classification. This matching can be done by a variety of approaches; one would be a configuration file containing a keyword-theme correlation listing. If based on keywords a theme from the theme classification has been identified, the probability is passed from the keyword list to the identified theme. As result, step 1 provides to the next processing step the problem message and a list of themes with probabilities.

Step 2 in FIG. 4A: This step begins processing on the result of step 1. As additional input, Step 2 considers the Peers Theme Lists. The Peers Theme Lists is the collection of one list of themes per peer where a theme on such a list has been added
by the peer in a certain problem area by setting preferences
by a rating by a peer as knowledgeable in a certain problem area to a certain degree

Step 2 now matches the incoming list of themes with probabilities against all peer theme lists. Whenever a theme is found on both lists, the peer is added to the peer list which is a result of this processing step. As a result, step 2 delivers to the next step the problem message, a list of peers and a list of themes with probabilities. Thus, from all peers who could work on the problem, the sub-set, which are the suitable candidates for this problem have been selected.

Step 3 in FIG. 4B: This step starts processing when the result of step 2 is received. In addition, this step takes the social network metrics and the performance metrics into consideration. Then this step could be implemented as:
For each expert, compute a overall rank (OR) for being the candidate for processing this problem message per associated theme on the theme list by:
Total Themes Rank (TTR)=sum (rank per theme * theme probability) where rank per theme is computed by the social metrics, an example could be:
Expert 1: Theme A, 40%—rank 5, Theme B, 80%—rank 3 [symbol] TTR=5*0.4+3*0.8=4.4
Expert 2: Theme A, 40%—rank 2, Theme B, 80%—rank 4 [symbol] TTR=2*0.4+4*0.8=4
   Since in the first step a list of themes has been associated with the problem message with probabilities per theme with this step we compute the overall “likelihood” that a peer from the list of peers is suitable considering all suggested themes for this problem.
overall rank (OR)=TTR*performance score (performance score as overall result by performance metrics) With this computation step, we take the performance of the peer into consideration which means the higher the overall rank, the better the combination of performance and skill alignment is as indicated by the theme selection for making the peer suitable.
As a result, step 3 provides the problem message and a list of ranked peers to step 4.

Step 4 in FIG. 4B: This step starts when step 3 is completed based on the result of the previous step. This step has the following input parameters:
Customer profitability metrics: As mentioned earlier, there are many different metrics. We assume for step 4 that we get an overall customer profitability score which might have been computed by using weights for the individual metrics for balancing them based on which one(s) is considered particularly relevant. This value is used to re-prioritize the problem message which means the priority assigned by the solution searcher is either replaced/re-balanced with this score for further processing in this step. In essence: The higher the customer profitability score, the better the expert assigned by the distribution rule algorithm (mostly) independent from the problem priority assigned by the problem searcher to the problem message.
Resource Planning: For the list of ranked peers, we consider values such as:
Availability: For example, if the peer is on vacation, the peer is removed from the candidate list
Workload: This could be a parameter indicating how many problems the peer has currently to process—the smaller the amount of problems, the higher the selection probability
SLAs: These are the service level agreements for the support contract between the customer who submitted the problem for a product and the company producing the problem.
Escalation table for expire timeouts used to set the check time (see Appendix on Escalation Table for details)
A configuration table to configure the distribution rule algorithm regarding the number of processors assigned, examples could be:
For problem messages with very high priority based on customer profitability assign all experts from the first and second highest rank.
For problem messages with low priority based on customer profitability assign only one low ranking expert.
For the most profitable customers, always route the problem message to the top ranked in house experts.
   With this input, step 4 does:
Remove all peers from ranked peer list which are not available based on information from the resource planning.
Remove if configured in the configuration table all online experts for the most profitable customers on initial message routing and only consider the top most ranked in house experts
Re-prioritize problem message priority based on customer profitability
Select from the list of ranked peers the ones applicable based on new priority of problem message creating the applicable, ranked peer list.
If for new priority list of applicable peers from ranked peer list is empty, pick peer with closest rank which is available and not overloaded from workload perspective
Select from the list of applicable, ranked peers the one(s) with lowest workload based on resource planning information and apply
SLA information
Escalation table information
Configuration table information
As a result, after step 4 we have the output:
When the Distribution Algorithm completes, the following is achieved:
problem message is routed to the right list of processors
list of processors is notified
check time is updated and it is ensured that the SLA is kept using appropriate escalation with either monitoring or scheduling infrastructure. The check time is the time when the monitoring component triggers a re-routing of the problem message if no solution has been provided by that time.

Appendix on Escalation Table:

As said, the preferred embodiment of this invention dictates that the initial response and the problem resolution time as agreed with the support contract are satisfied at all times. Let's assume the following for illustration:

| | Time until initial | Time until problem |
|---|---|---|
| Priority | response | resolution |
| Very High | 4 h | 2 days |
| High | 8 h | 4 days |
| Medium | 1 day | 2 weeks |
| Low | 1 week | 4 weeks |

So if the company hosting the Support 2.0 Customer Care platform agreed to a support contract with the time schedules as outlined above, then this needs to hold true even if the problem message is routed at some point to a peer in the Peer Customer Care 2.0 platform versus to a peer in the in house support organization. If a problem message is routed to the Peer Customer Care 2.0 platform through a monitoring component the time until the above deadlines are hit are monitored on an ongoing basis. Assume the peer who got the problem message assigned is sick or on vacation or can't look at the problem message for some other reason, there has to be a way to detect this early enough and re-route the problem message to someone else. The detection is possible through the monitoring component. However, the monitoring component needs to have a proper configuration table when the problem message needs to be submitted again to the distribution rules algorithm which then needs to decide how to re-route the message again. Here the company needs the ability to influence when the distribution rules algorithm must route the problem message to the in house support organization so that a peer being an in house employee is taking care of the issue in time. Also the notification representing the escalation if such a re-route is needed needs to be configurable. For example, it could be that SMS and email is used at the same time for peer notification for a high priority message where for a low priority message only email is used. To illustrate these thresholds configuration options, look at the table below:

| | | | | 1. | | | |
|---|---|---|---|---|---|---|---|
| | Priority of | | | Re- | | 2. | Notification |
| Priority | Customer | Initial | Problem | route | Notification | Re-route | mechanism |
| of | based on | response | resolved | by | mechanism | by | and |
| message | profitability | (IR) | (PR) | threshold 1 | and location | threshold 2 | location |
| Very | Very High | 4 h | 2 days | 2 h left | SMS/email | — | — |
| high | | | | to IR/ | In house | | |
| | | | | 1 day | support | | |
| | | | | left to | (CRM) | | |
| | | | | PR | | | |
| Very | Low | 4 h | 2 days | 2 h left | RSS feed, | 1 h left to | SMS/ |
| High | | | | to IR/ | Online | IR/ | email |
| | | | | 1 day | support | 8 h left to | In |
| | | | | left to | Forum | PR | house |
| | | | | PR | | | support |
| | | | | | | | (CRM) |
| Low | Very High | 1 week | 4 weeks | 3 d left | RSS | 8 h left to | SMS/ |
| | | | | to IR/ | feed/email | IR/ | email, |
| | | | | 3 week | Online | 3 weeks | In |
| | | | | and 2 | support | left to PR | house |
| | | | | days | Forum | | support |
| | | | | left to | | | (CRM) |
| | | | | PR | | | |
| Medium | Low | 1 day | 2 weeks | 8 h left | RSS feed, | 1 h left to | email, |
| | | | | to IR/ | Online | IR/ | In |
| | | | | 1 week | support | 8 h left to | house |
| | | | | left to | Forum | PR | support |
| | | | | PR | | | (CRM) |

Note that the re-route thresholds are checked for by the monitoring component.
Compare the first and the second row now. Both problem messages have been submitted by a problem searcher with the highest priority. However, based on the customer priority derived by considering profitability metrics they are treated differently regarding the routing destinations based on the expiry timeouts:
You can have any number of thresholds—we show only two above. As soon as the problem reaches in house support for a threshold, it is not re-routed anymore as indicated by a “-” in later thresholds columns (see the first row as example) and it is assumed that in house support resolves it then finally. Problems from customers with a very high priority score are routed earlier to in house support to enhance proper resolution and mitigate risk that time is running out before someone starts looking at the problem.
Low profitable customer problem messages are left much longer in the online support platform before they are routed to the in house support organization increasing the chance that they are resolved online. Therefore, paid in house support employees are more likely spending their time on problem message from customers with high profitability.
Compare the third and fourth row now. Even though the problem priority is lower in the third row due to the fact that the customer has the much better profitability score as indicated in the second column, the thresholds ensure that the problem reaches in house support earlier and the notification mechanism used for escalation are multifold indicating higher urgency. Here again it is clearly visible how the profitability ranking is used to favor more profitable customers in the support process overriding the traditional approach to just use a problem message priority indicator delivering a much better support experience to the profitable customers.

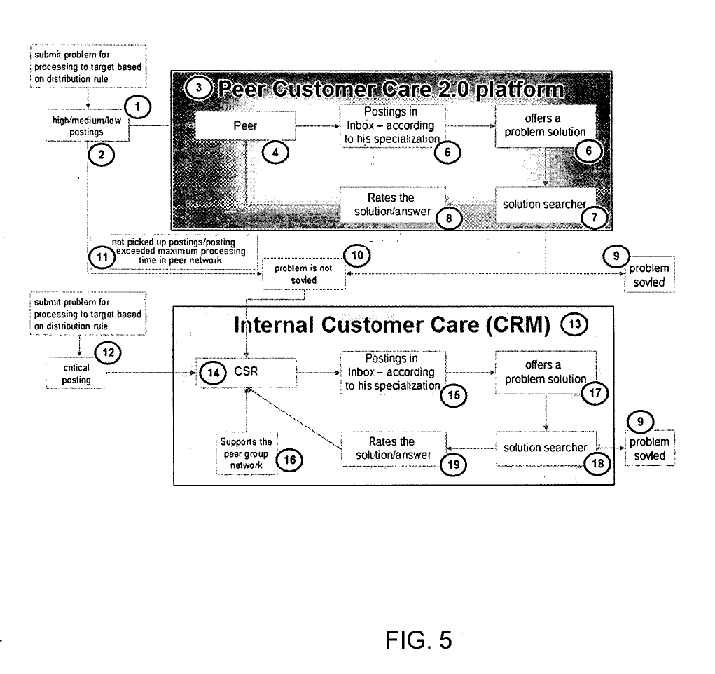

Once the distribution rules algorithm determined a destination to which the problem is routed as discussed the next part of the invention is the processing involved with arriving at a solution to a problem. This process flow involved with answering a problem is shown in FIG. 5.

When a solution searcher submits a problem, there are on a high level two possible destinations:
The Peer Customer Care 2.0 platform (3) in a forum (e.g. one for Performance issues, one for Install problems, etc.)
Internal Customer Care organization (13) which usually uses a CRM system (component 1 in FIG. 1).
The process now works as follows:
1. The distribution rules algorithm processes the problem according to algorithm. Depending on the computation result, it submits (1) the problem posting to the Peer Customer Care 2.0 platform (3) or to the in house support represented by the internal customer care (13) system. Otherwise (2) if the posting has not been picked up at all or did not receive a complete solution within the expiry duration in the peer network, it is considered not solved (10) and ultimately routed to the internal customer care organization (3) with an appropriate rule (see explanation of Table 1 above). The expiry duration is periodically checked as illustrated with component (14) in FIG. 2.
2. A Peer (4) receives the problem posting in his inbox (5) based on his specialization. The specialization can be a result of preferences settings on topics selected (available to the Peer Customer Care 2.0 platform from the MDM System). Optionally, if present this specialization can be a result of tagging in the social network infrastructure of the Peer Customer Care 2.0 platform where other peers tagged him as “expert” on a subject matter area or a combination thereof. Since the peer is notified immediately when a problem posting was done, this improves the likelihood that the problem is solved quickly for the solution searcher. For the peer after all there is an incentive to answer quickly because if someone else (another peer who might receive the problem posting as well) provides the solution first, the credits for it are lost and thus the chances to receive “Peer of the Month”-awards and similar incentives reduced. Since the peer is a subject matter expert in the problem area, the expert knowledge increases also the quality of the response.
3. The peer offers a solution (6) posted in a forum or as blog entry or as article in a wiki, etc. There are several key aspects here:
The solution searcher is notified about the solution posting immediately.
The posting is available in public (see step (4) on search) thus improving further search results of other solution searchers right away increasing speed of problem resolution.
The company hosting the Support 2.0 Customer Care platform benefits multifold from this:
Without additional investment the knowledge base grows in public.
A possible solution was provided by a peer at zero cost for the company other than hosting the Peer Customer Care 2.0 platform integrated with in house support because no CCR employee was needed to participate in this process.
Customer loyalty grows since community works.
4. The solution searcher (7) reviews the possible solution posting and rates (8) the peer. This gives credit to the peer growing the peers reputation and credit score. Now there are two cases possible:
The solution provided by the peer was complete and thus the problem is solved (9).
The solution was not complete. Assuming the expiry duration in the peer network is not exceeded yet the cycle through steps (4) to (8) repeats until a solution is found or the expiry duration is exceeded in which case the problem is considered not solved (10) and routed to the internal customer care organization (13). The routing of the problem is again determined by the very basic distribution rules as discussed previously. The expiry duration is periodically checked as illustrated with component (14) in FIG. 2.
5. The problem posting reaches the internal customer care organization (13) in one of two possible ways:
Problem was not solved (10) completely in peer network or problem posting was not processed at all in Peer Customer Care 2.0 platform
Problem posting was considered critical by the distribution rules algorithm and routed directly to the in house support organization.
6. In either case, a CCR (14) will find at some point in time the problem posting (15) in his inbox if the posting belongs to his specialization. The CCR uses the CRM System for the customer care process. The CCR performs as peer (16) as well.
7. The CCR creates a possible solution (17) which is posted in a forum (if the technologies are present in the Peer Customer Care 2.0 system it could also be a blog entry or as article in a wiki, etc). The posting appears in the Peer Customer Care 2.0 platform in a forum (see also step (4) on search) and the solution searcher is notified similarly to the notification in the peer network case. The benefits are similar to step 3 above.
8. The solution searcher (18) rates (19) the solution provided and assigns credit. Thus the CCR is treated like a peer from another customer. If the solution is complete, the process finishes (9). Otherwise the steps (14) to (19) are repeated.

Note that through the ongoing monitoring through the monitoring component and escalation through this component at all times the support contract response and resolution times for the problems are guaranteed. Therefore, the described system architecture and process unites the in house and online support organizations.

### II. Computerized Implementation

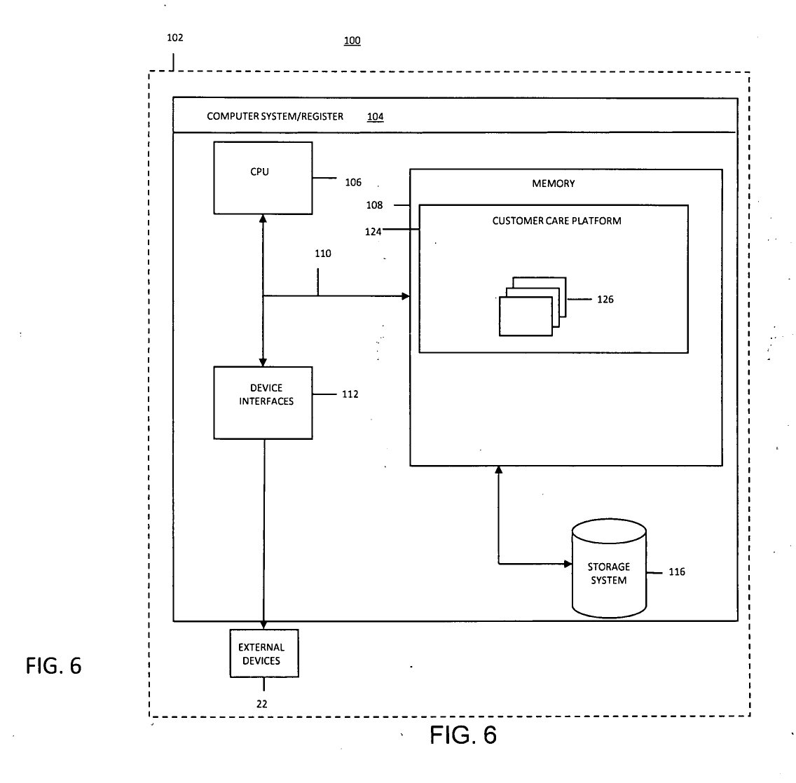

Referring now to FIG. 6, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

Computer system is intended to represent any type of computer system that may be implemented in deploying/realizing the teachings recited herein. It should be understood that any other computers implemented under the present invention will have similar components, but may perform different functions/have different software. As shown, computer system 104 includes a processing unit 106, a memory 108, a bus 110, and device interfaces 112. Further, computer system 104 is shown communicating with one or more external devices 114 that communicate with bus via device interfaces. In general, processing unit 106 executes computer program code, such customer care platform 124, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a kiosk, a checkout station, a keyboard, a pointing device, a display, etc.); one or more devices that enable a user to interact with computer system 104; and/or any devices (e.g., network card, modem, etc.) that enable computer system 104 to communicate with one or more other computing devices. Although not shown, computer system 104 could contain multiple processing units.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 2 can be included in computer system 104.

Storage system 116 can be any type of system (e.g., storage units 116 of FIG. 6) capable of providing storage for information under the present invention. To this extent, storage system 116 could include one or more storage devices such as magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is customer care platform 124, which has a set of modules 126. Set of modules 126 generally provide the functions of the present invention as described herein. For example, (among other things), set of modules 126 is configured to receive problems, determine distribution rules, offer problems to solutions, rate answers, find and communicate with a specialist, etc

While shown and described herein as a framework for customer care/support, it is understood that the invention further provides various alternative embodiments. For example, in one embodiment, the invention provides a computer-readable/useable medium that includes computer program code to enable a computer infrastructure to provide customer care/support as described herein. To this extent, the computer-readable/useable medium contains program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 6) and/or storage system 116 (FIG. 6) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide customer care/support as described herein. In this case, the service provider can create, maintain, support, etc., a computer infrastructure, such as computer infrastructure 102 (FIG. 6) that performs the process of the invention for one or more customers. In return, the service provider can receive payment from the customers under a subscription and/or fee agreement and/or the service provider can receive payment from the sale of advertising content to one or more third parties.

In still another embodiment, the invention provides a computer-implemented method for variable energy pricing. In this case, a computer infrastructure, such as computer infrastructure 102 (FIG. 6), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 6), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers. Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A customer support method, comprising:
performing a search for set of possible solutions to a problem, the set of possible solutions comprising online support and in-house support;
identifying and notifying a peer to assist with resolution of the problem in response to a notification of the problem;
receiving feedback on the set of possible solutions via a ratings system; and
monitoring compliance with a Service Level Agreement (SLA) for both the in-house support and the online support in resolving the problem.

2. The customer support method of claim 1, the peer being identified using a distribution rules algorithm.

3. The customer support method of claim 2, the distribution rules algorithm comprising considering text analytics and theme classification dictionaries for theme classification of the problem.

4. The customer support method of claim 2, the distribution rules algorithm comprising considering a social network analysis to identify peers which are considered experts.

5. The customer support method of claim 2, the distribution rules algorithm comprising considering peer performance.

6. The customer support method of claim 2, the distribution rules algorithm comprising considering a profitability of a customer experiencing the problem in implementing the customer support method.

7. The customer support method of claim 6, the profitability being based on a set of metrics.

8. The customer support method of claim 7, the set of metrics comprising at least one of the following: a total revenue value of the customer, a potential to cross-sell the customer, an average discount rate for the customer, a quantity of sales to the customer, an average time between the sales, and an average number of customer service requests received from the customer.

9. The customer support method of claim 2, the distribution rules algorithm comprising considering peer availability and peer workload indicated by assigned problems.

10. The customer support method of claim 2, the distribution rules algorithm comprising considering a mechanism to escalate a priority of a problem based on an escalation table.

11. A customer support system, comprising:
a module for performing a search for set of possible solutions to a problem, the set of possible solutions comprising online support and in-house support;
a module for identifying and notifying a peer to assist with resolution of the problem in response to a notification of the problem;
a module for receiving feedback on the set of possible solutions via a ratings system; and
a module for monitoring compliance with a Service Level Agreement (SLA) for both the in-house support and the online support in resolving the problem.

12. The customer support system of claim 11, the module for identifying and notifying the peer implementing a distribution rules algorithm.

13. The customer support system of claim 12, the distribution rules algorithm comprising considering peer performance based on a set of metrics, the set of metrics comprising previous peer performance.

14. The customer support system of claim 12, the distribution rules algorithm comprising considering a profitability of a customer experiencing the problem in implementing the customer support system, the profitability being based on a set of metrics.

15. The customer support system of claim 14, the set of metrics comprising at least one of the following: a total revenue value of the customer, a potential to cross-sell the customer, an average discount rate for the customer, a quantity of sales to the customer, an average time between the sales, and an average number of customer service requests received from the customer.

16. A computer readable medium containing a program product for customer support, the computer readable medium comprising instructions for causing a computer system to:
perform a search for set of possible solutions to a problem, the set of possible solutions comprising online support and in-house support;
identify and notifying a peer to assist with resolution of the problem in response to a notification of the problem;
receive feedback on the set of possible solutions via a ratings system; and
monitor compliance with a Service Level Agreement (SLA) for both the in-house support and the online support in resolving the problem.

17. The computer readable medium containing the program product of claim 16, the computer readable medium further comprising instructions for causing the computer system to: identify and notify the peer based on a distribution rules algorithm.

18. The computer readable medium containing the program product of claim 17, the distribution rules algorithm comprising considering peer performance based on a set of metrics, the set of metrics comprising previous peer performance.

20. The computer readable medium containing the program product of claim 17, the distribution rules algorithm comprising considering a profitability of a customer experiencing the problem in implementing the customer support system, the profitability being based on a set of metrics.

21. The computer readable medium containing the program product of claim 20, the set of metrics comprising at least one of the following: a total revenue value of the customer, a potential to cross-sell the customer, an average discount rate for the customer, a quantity of sales to the customer, an average time between the sales, and an average number of customer service requests received from the customer.

22. A method for deploying an application for customer support, comprising: providing a computer infrastructure being operable to:
perform a search for set of possible solutions to a problem, the set of possible solutions comprising online support and in-house support;
identify and notifying a peer to assist with resolution of the problem in response to a notification of the problem;
receive feedback on the set of possible solutions via a ratings system; and
monitor compliance with a Service Level Agreement (SLA) for both the in-house support and the online support in resolving the problem.
